(19) United States
(12) Patent Application Publication
(10) Pub. No.: US 2025/0205957 A1
(43) Pub. Date: Jun. 26, 2025

(54) Non-Sealable, Matte, BOHDPE Films and Labels

(71) Applicant: JFE Virton SRL, Virton (BE)

(72) Inventors: Alain Marchal, Villers-le-Rond (FR); Gabriel Domingos, Gorcy (FR)

(73) Assignee: JFE Virton SRL, Virton, LU (BE)

(21) Appl. No.: 19/077,380

(22) Filed: Mar. 12, 2025

Related U.S. Application Data
(63) Continuation of application No. PCT/IB2024/053441, filed on Apr. 8, 2024.
(60) Provisional application No. 63/525,769, filed on Jul. 10, 2023.

(51) Int. Cl. B29C 48/21; B29C 48/00; B29K 23/00; B29K 91/00; B29K 105/00; B29L 31/00

(52) U.S. Cl. CPC B29C 48/21; B29C 48/0018; B29C 48/022; B29K 2023/065; B29K 2023/16; B29K 2091/00; B29K 2105/0085; B29K 2105/0097; B29K 2995/0024; B29K 2995/0025; B29K 2995/0051; B29K 2995/0053; B29L 2031/744

(57) ABSTRACT

Disclosed, in one example embodiment, is a polyethylene film or label comprising a core layer may include at least about 80 wt. % high-density polyethylene. Further, the polyethylene film may include, optionally, a first tie layer on a first side of the core layer, wherein the first tie layer comprises at least about 60 wt. % high-density polyethylene, and, may further include, optionally, a second tie layer on a second side of the core layer, wherein the second tie layer comprises at least about 60 wt. % high-density polyethylene. Further still, the polyethylene film may include a non-sealable, external, matte skin layer having a minimum haze of about 60% under ASTM D-1003 and a maximum gloss at 45° of about 15 under ISO2813. Yet further, the polyethylene film has a dull appearance and does not heat-seal on a polyethylene laminate before shrinking or deforming the polyethylene film.

### REFERENCE TO RELATED APPLICATION

This is a continuation application from and that claims priority to PCT application serial number PCT/IB2024/053441 filed on 4 Apr. 2024, which claims priority to U.S. provisional patent application Ser. No. 63/525,769 filed on 10 Jul. 2023, wherein each is hereby incorporated by this reference in its entirety.

### FIELD

This disclosure relates to compositions of oriented, high-density, polyethylene films, including methods and uses pertaining to the same, and adhesion to face stock, which is at least substantially free from silicone.

### BACKGROUND

Current pressure-sensitive label laminations in the market for items such as bottle labels use a lamination of face stocks to release liners, such as PET, paper, and BOPP. However, combinations of dissimilar materials pose recyclability problems. Also, release liners are coated with silicone in a separate process step, which adds cost to the overall structure. Needs exist for recyclability solutions, such as by replacing dissimilar materials in the laminations by producing all-PE films that are made to provide other desirable characteristics, such as good pressure-sensitive label release performance along with improvements in cost, resource and/or manufacturing time and ease.

### SUMMARY

In one example embodiment, disclosed is a polyethylene film comprising a core layer may include at least about 80 wt. % high-density polyethylene. Further, the polyethylene film may include, optionally, a first tie layer on a first side of the core layer, wherein the first tie layer comprises at least about 60 wt. % high-density polyethylene, and, may further include, optionally, a second tie layer on a second side of the core layer, wherein the second tie layer comprises at least about 60 wt. % high-density polyethylene. Further still, the polyethylene film may include a non-sealable, external, matte skin layer having a minimum haze of about 60% under ASTM D-1003 and a maximum gloss at 45′ of about 15 under ISO2813. Yet further, the polyethylene film has a dull appearance and does not heat-seal on a polyethylene laminate before shrinking or deforming the polyethylene film.

### BRIEF DESCRIPTION OF THE DRAWINGS

FIG. 1 shows a sealing curve for a vertical form fill seal (“VFFS”) packaging machine, i.e., an automated packaging system that forms, fills, and seals bags or pouches vertically, of scaling strength versus jaw temperature for an example embodiment of the inventive film with the below-discussed matte skin layer laminated to a polyethylene substrate that has a sufficiently high SIT while remaining uniformly stretchable under the cold conditions used for BOHDPE.

FIG. 2 shows three more sealing curves for gussets and a lap seal of sealing strength versus jaw temperature for example embodiments of the inventive film with the below-discussed matte skin layer laminated to a polyethylene substrate or to itself that has a sufficiently high SIT while remaining uniformly stretchable under the cold conditions used for BOHDPE.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Various specific embodiments, versions and examples are described now, including exemplary embodiments and definitions that are adopted herein for purposes of understanding. While the following detailed description gives specific preferred embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “elastomer” is defined as a propylene-based or ethylene-based copolymer that can be extended or stretched with force to at least 100% of its original length, and upon removal of the force, rapidly (e.g., within 5 seconds) returns to its original dimensions.

As used herein, “plastomer” is defined as a propylene-based or ethylene-based copolymer having a density in the range of 0.850 g/cm³ to 0.920 g/cm³ and a DSC melting point of at least 40° C.

As used herein, “intermediate” is defined as the position of one layer of a multilayered film, wherein said layer lies between two other identified layers. In some embodiments, the intermediate layer may be in direct contact with either or both of the two identified layers. And/or in other embodiments, additional layers may also be present between the intermediate layer and either or both of the two identified layers.

As used herein, “substantially free” is defined to mean that the referenced film layer is largely, but not wholly, absent a particular component. In some embodiments, small amounts of the component may be present within the referenced layer as a result of standard manufacturing methods, including recycling of film scraps and edge trim during processing.

By “consist essentially of,” what is meant, for example, is that a particular film layer does not have any more than 1 wt % or 2 wt % or 3 wt % or 4 wt % or 5 wt % of other polymers in the bulk material constituting the film layer's composition, but “consist essentially of” does not exclude the possibility that the particular film layer also has additives, such as anti-slip agents, anti-blocking agents, anti-oxidants, pigments, whitening agents, cavitation agents, etc. regardless of what polymers or other materials make up the additive(s). “Consisting of” or “consisting,” by contrast, is a closed group, i.e., more restrictive than the restricted definition of “consisting essentially of,” and to that end, only contains the members of the group described by and following the words “consisting of.”

As used herein, “about” means the number itself and/or within 5% of the stated number. For instance, with about 5%, this means 5 and/or any number or range within the range of 4.75 to 5.25, e.g., 4.75 to 4.96, 4.81 to 5.1, etc.

This disclosure describes example multilayer oriented films comprising, consisting essentially of, or consisting of an external matte layer with an HDPE core. The films show have a nice dull appearance that may be reverse-printed and/or laminated to a PE sealant film (i.e. or other substrate in other embodiments) to produce a mono-material laminate, which may be formed into bags for food-packaging applications, that is recyclable.

This disclosure describes a coextruded bi-oriented HDPE film or label (collectively, “films”) that may have one side having a matte layer. The matte layer, i.e., low gloss with high haze, comprises, consists essentially of, or consists of HDPE resin and additional components to help provide uniform stretching. Viscosity matching of components as well as the thermal characteristics, i.e., seal-initiation temperature (“SIT”), of the matte layer are important to obtaining a uniform stretching for BOHDPE films. Furthermore, low-SIT matte films usually show a wider processing window during the orientation/stretching of the films with more uniform matte appearance.

As a result, a commercial film called 25HD230 (i.e., a Jindal Films™ BOHDPE EthyLyte™ film) shows good seal compatibility to itself, BOPE Sealtough™, blown PE, or OPP films, but also shows a limitation in its utilization when packaging conditions are leading to an Out-to-Out (means Mat-to-Mat) contact under significant pressure and temperature; the film sticks to itself. Two examples of such applications are gusset sealing of pre-made bags and lapscal sticking on VFFS machine.

A significant challenge resolved that led to this disclosure was development of an adequate matte skin material, which had a sufficiently high SIT while remaining uniformly stretchable under the cold conditions used for BOHDPE. This is more difficult than it sounds because those matte films working well in the PP world were not working well in the PE world! Optical properties were to remain on or above target, namely a haze higher than about 60% with Gloss 45° equal to or less than about 15. An example embodiment of the disclosed film as a matte skin/tic/core/tie/skin structure is demonstrated by Table 1, but this is by no means limiting. Notably, although not stated, any of these layer(s) may also include additive(s), as later described herein, that do not depart from the disclosed films. And, in countless permutations to result in other example embodiments of the disclose films, the wt. % of each of the stated compositions in Table 1′s tie and core layers may differ so long as each tie has at least about 60 wt. %, 65 wt. %, 70 wt. %, 75 wt. %, or 80 wt. % or more HDPE (or any range within the foregoing wt. %'s), and the core has at least about 80 wt. %, 85 wt. %, 90 wt. %, or 95% wt. % or more HDPE (or any range within the foregoing wt. %'s). The masterbatch solution may be a PE masterbatch solution for the antiblock in the other skin layer. The total thickness of the disclosed films may be from 10 μm through 100 μm in various embodiments.

TABLE 1

| Composition | Wt. % | Commercial Name (Examples without Limit) | Thickness |
|---|---|---|---|
| Matte Skin Layer | 98 | Avient Mat PPC | 2 μm |
| (see Table 2) | | Wax, fluoropolymer, and/or stabilizer | |
| Processing aid(s) | 2 | | |
| HDPE | 60 | ExxonMobil HTA 108 | 2.4 μm |
| mLLDPE | 20 | Mitsui SP3022 or Dow TF80 | |
| OBC | 20 | Lyondellbassell X500F or Dow Elite AT6111 | |
| HDPE | 85 | ExxonMobil HTA 108 | 17.2 μm |
| mLLDPE | 15 | Mitsui SP3022 or Dow TF80 | |
| HDPE | 60 | ExxonMobil HTA 108 | 2.4 μm |
| mLLDPE | 20 | Mitsui SP3022 or Dow TF80 | |
| OBC | 20 | Lyondellbassell X500F or Dow Elite AT6111 | |
| EPB | 96 | Borealis TD312 or Ineos K2385 | 1 μm |
| antiblock masterbatch | 4 | Ampacet Seablock 4 | |
| (5% wt.) | | | |

Immediately below in Table 2 are examples of different polyolefin polyethylene resin “Matte Skin Layer” (s) in the biaxially oriented HDPE (“BOHDPE”) films having the structure shown by Table 1. The matte skin layer of the disclosed invention may comprise, consist essentially of, or consists of at least about 80 wt. % and more of polyethylene polymers, such as Avient MAT PPC1464, optionally in combination with processing aids and/or additives.

TABLE 2

| | | | | Haze | Glass | |
|---|---|---|---|---|---|---|
| | SIT Matte | Skin | Appearance | % | 45° | Comment |
| External Matte Skin | Layer (° C.) | Thickness | Uniformity | ≥60 | ≤15 | Preliminary Target |
| Ampacet MAT | 75 | 2.1 | very good | 68 | 8.5 | Commercial Grade |
| PPC0007 | | | | | | 25HD230 |
| (Sealable Reference) | | | | | | (Reference) |
| Ampacet MATIF 120 | 120 | 2.1 | NA | | | NOK - unstretched |
| | | | | | | matte skin |
| Ampacet MATIF 105 | 105 | 2.1 | very good | 32 | 27 | NOK - haze/glass |
| | | | | | | target not reached |
| Ampacet MATIF 95 | 95 | 2.1 | very good | 30 | 47 | NOK - haze/glass |
| | | | | | | target not reached |
| Ampacet MATIF LST18 | | 2.1 | good | 32 | 33 | NOK - haze/glass |
| | | | | | | target not reached |
| Ampacet MATIF 85 | 85 | 2.1 | good | 45 | 21 | NOK - haze/glass |
| | | | | | | target not reached |
| Ampacet MATIF 75 | 75 | 2.1 | medium | 35 | 17 | NOK - haze/glass |
| | | | | | | target not reached |
| CONSTAB MAT02490 | | 2.1 | NA | 13 | 68 | NOK - not mat |
| Avient MAT PPC1464 | >100 | 2.0 | very good | 79 | 7 | OK - Potential Non- |
| | | | | | | Sealable Prototype |
| Argus ARX V 15/ | | 2.1 | good | 10 | 79 | NOK - not matte |
| 502 DIV-PP | | | | | | |
| Argus ARX V 21/ | 80 | 2.1 | good | 40 | 24 | NOK - haze/glass |
| 458 DIV-PP | | | | | | target not reached |
| 60% HDPE M6040 + | | 2.2 | not good | 51 | 15 | NOK - unacceptable |
| 40% CPS 5050HD | | | | | | cloudy appearance |
| 60% HDPE M6040 + | | 2.2 | medium | 71 | 8 | NOK - non-uniform |
| 40% Vistamax VM6102 | | | | | | mat appearance |
| 50% KS407 + | | 2.1 | good | 28 | 30 | NOK - haze/glass |
| 50% Lumicene M6040 | | | | | | target not reached |
| 50% Adsyl 5C39 + | | 2.1 | good | 32 | 27 | NOK - haze/glass |
| 50% Lumicene M6040 | | | | | | target not reached |
| 35% KS407 + | | 2.1 | good | 24 | 34 | NOK - haze/glass |
| 65% Total HF513 | | | | | | target not reached |
| 50% HMA018/ | | 2.0 | not good | 46 | 18 | NOK - haze/glass |
| 50% KS407 | | | | | | target not reached |
| 50% HMA018/ | | 2.0 | NA | 22 | 44 | NOK - not matte |
| 50% VM6102 | | | | | | |
| 50% HMA018/ | | 2.0 | medium | 30 | 34 | NOK - haze/glass |
| 50% PM2060 | | | | | | target not reached |
| 50% HMA018/ | | 2.0 | medium | 46 | 19 | NOK - haze/glass |
| 50% KS385 | | | | | | target not reached |
| 50% HMA018/ | | 2.0 | NA | 21 | 47 | NOK - not matte |
| 50% TF80 | | | | | | |
| Schulman DUL 3636 | | 2.0 | NA | 17 | 61 | NOK - not matte |
| DP183 | | | | | | |
| Schulman DUL 3636 | | 2.0 | NA | 12 | 71 | NOK - not matte |
| LTX-5 (for low SIT | | | | | | |
| films) | | | | | | |
| 50% HMA018/ | | 2.0 | medium | 27 | 35 | NOK - haze/glass |
| 50% PN2060 | | | | | | target not reached |

For Table 2 values, haze, and gloss at 45° were measured according to ASTM D-1003 and ISO2813, respectively. As seen in Table 2, the majority of tested matte non-sealant skin candidates failed (i.e., “NOK”=not ok) because either it did not provide the optical “preliminary target” listed toward the top of Table 2 or it provided a non-uniform matte appearance as part of the BOHDPE film. As a result, Avient MAT PPC1464, and those like it as described in this paragraph, were considered as a possible matte skin candidate for a non-sealable matte version of for a BOHDPE film, such as a modified Jindal Films™ 25HD230 that would have a non-sealable matte skin layer.

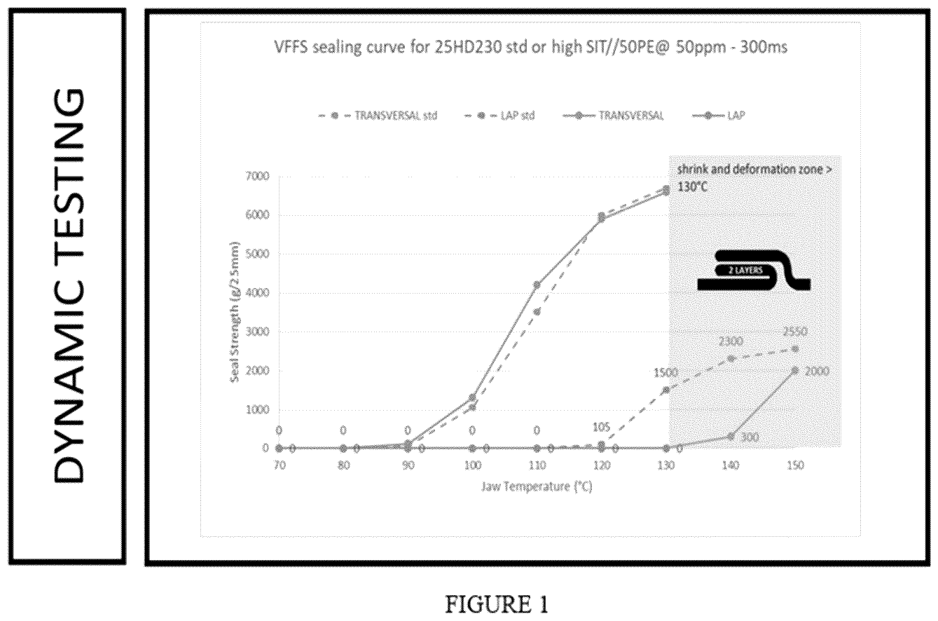

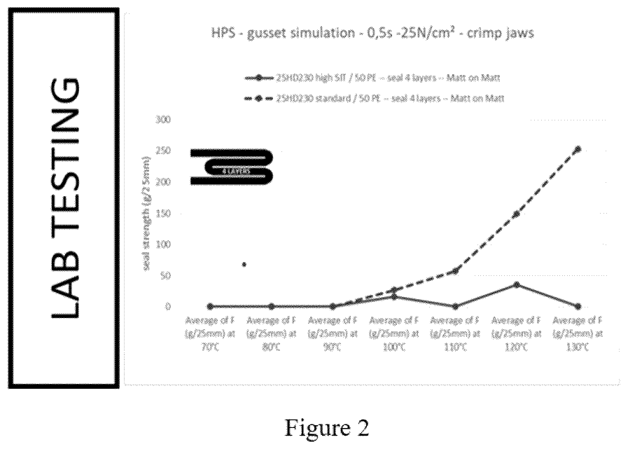

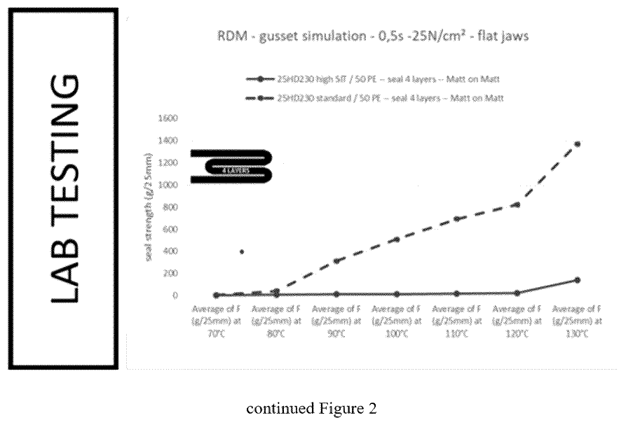

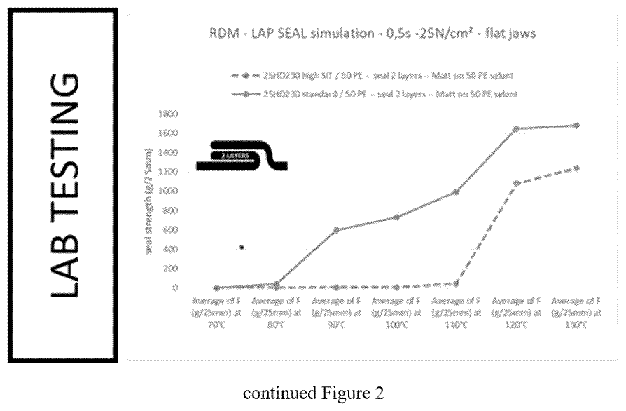

The sealing results obtained in the lab on sealing equipment and on VFFS packaging machine confirm that the disclosed films having the above-described, external, matte, skin layer would not seal on itself or on PE sealant web before being damaged by the corresponding heat (shrink or deformation). Both dynamic testing trying to lapseal on the VFFS and lab scale testing showed a gain of at least 25-30° C. in SIT on the matte side giving the extra operating room avoiding out/out scaling issue, as shown on below graphs. In the lab with simulating gusset (4-layers of film), the non-sealant prototype did not create problems anymore during gusset sealing of pre-made bags. FIGS. 1 and 2 provide data points shedding further light on the disclosed films.

In other example embodiments, the films are two-layered films, which comprise, consists essentially of, or consists of the matte skin layer and the core layer in Table 1 or variations thereof as described in the paragraph immediately above Table 1, and three-layered and four-layered example embodiments comprise, consists essentially of, or consists of the matte skin layer, tie layer(s), and the core layer in Table 1 or variations thereof as described in the paragraph immediately above Table 1.

### Additives

Additives present in the film's layer(s) may include, but are not limited to opacifying agents, pigments, colorants, cavitating agents, slip agents, antioxidants, anti-fog agents, anti-static agents, anti-block agents, fillers, moisture barrier additives, gas barrier additives, gas scavengers, and combinations thereof. Such additives may be used in effective amounts, which vary depending upon the property required, in any one or more of the layers' compositions described in Tables 1 and 2 in further example embodiments, which do not depart from the scope of the disclosed inventions.

Examples of suitable opacifying agents, pigments or colorants are iron oxide, carbon black, aluminum, titanium dioxide (TiO₂), calcium carbonate (CaCO₃), and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful is erucamide.

Non-migratory slip agents, used in one or more skin layers of the multilayered films, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Useful fillers may include finely divided inorganic solid materials such as silica, fumed silica, diatomaceous earth, calcium carbonate, calcium silicate, aluminum silicate, kaolin, talc, bentonite, clay, and pulp.

Optionally, nonionic, or anionic wax emulsions can be included in the coating(s), i.e., skin layer(s), to improve blocking resistance and/or lower the coefficient of friction. For example, an emulsion of Michem Lube 215, Michem Lube 160 may be included in the skin layer(s). Any conventional wax, such as, but not limited to Carnauba™ wax (commercially available from Michelman Corporation of Cincinnati, Ohio) that is useful in thermoplastic films is contemplated.

### Metallization

The outer surface (i.e., side facing away from the core) of a skin layer and/or laminating substrate may undergo metallization after optionally being treated. Metallization may be carried out through conventional methods, such as vacuum metallization by deposition of a metal layer such as aluminum, copper, silver, chromium, or mixtures thereof. Following metallization, a coating may be applied to the outer metallized layer “outside” or “inside” the vacuum chamber to result in the following structure: metallized layer/skin layer/optional tie layer/core/optional tie layer/skin layer/metallized layer. In an additional embodiment, a primer may be applied on the metal surface(s) followed by top coating(s).

In certain embodiments, the metal for metallization is metal oxide, any other inorganic materials, or organically modified inorganic materials, which are capable of being vacuum deposited, electroplated or sputtered, such as, for example, SiOx, AlOx, SnOx, ZnOx, IrOx, wherein x=1 or 2, organically modified ceramics “ormocer”, etc. The thickness of the deposited layer(s) is typically in the range from 100 to 5,000 Angstrom or preferably from 300 to 3000 Angstrom.

### Surface Treatment

One or both of the outer surfaces of the multilayered films may be surface-treated to increase the surface energy to render the film receptive to metallization, coatings, printing inks, adhesives, and/or lamination. The surface treatment can be carried out according to one of the methods known in the art including corona discharge, flame, plasma, chemical treatment, or treatment by means of a polarized flame.

### Priming

An intermediate primer coating may be applied to multilayered films. In this case, the film may be first treated by one of the foregoing methods to provide increased active adhesive sites thereon and to the thus-treated film surface there may be subsequently applied a continuous coating of a primer material. Such primer materials include, for example, epoxy, poly (ethylene iminc) (PEI), and polyurethane materials. U.S. Pat. Nos. 3,753,769, 4,058,645 and 4,439,493, each incorporated herein by reference, discloses the use and application of such primers. The primer provides an overall adhesively active surface for thorough and secure bonding with the subsequently applied coating composition and can be applied to the film by conventional solution coating means, for example, by roller application.

### Orienting

The films herein are also characterized in certain embodiments as being biaxially oriented. The films can be made by any suitable technique known in the art, such as a tentered or blown process, LISIM™, and others. Further, the working conditions, temperature settings, lines speeds, etc. will vary depending on the type and the size of the equipment used. Nonetheless, described generally here is one method of making the films described throughout this specification. In a particular embodiment, the films are formed and biaxially oriented using the tentered method. In the tentered process, line speeds of greater than 100 m/min to 400 m/min or more, and outputs of greater than 2000 kg/h to 4000 kg/h or more are achievable. In the tenter process, sheets/films of the various materials are melt-blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm. The extruded film is then cooled using air, water, or both. Typically, a single, large diameter roll partially submerged in a water bath, or two large chill rolls set at 20 or 30 to 40 or 50 or 60 or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80 to 100 or 120 or 150° C., in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, but high enough to facilitate the machine direction orientation process. Such temperatures referred to herein refer to the film temperature itself. The film temperature can be measured by using, for example, infrared spectroscopy, the source aimed at the film as it is being processed; those skilled in the art will understand that for transparent films, measuring the actual film temperature will not be as precise. The heating means for the film line may be set at any appropriate level of heating, depending upon the instrument, to achieve the stated film temperatures.

The lengthened and thinned film is passed to the tenter section of the line for TD orientation. At this point, the edges of the sheet are grasped by mechanical clips on continuous chains and pulled into a long, precisely controlled hot air oven for a pre-heating step. The film temperatures range from 100 or 110 to 150 or 170 or 180° C. in the pre-heating step. Again, the temperature will be below that which will melt the film, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the process temperature is lowered by at least 2° C. but typically no more than 20° C. relative to the pre-heat temperature to maintain the film temperature so that it will not melt the film. After stretching to achieve transverse orientation in the film, the film is annealed at a temperature below the melting point, and the film is then cooled from 5 to 10 or 15 or 20 or 30 or 40° C. below the stretching temperature, and the clips are released prior to edge trim, optional coronal, printing and/or other treatment can then take place, followed by winding.

Thus, TD orientation is achieved by the steps of pre-heating the film having been machine oriented, followed by stretching and annealing it at a temperature below the melt point of the film, and then followed by a cooling step at yet a lower temperature. In one embodiment, the films described herein are formed by imparting a transverse orientation by a process of first pre-heating the film, followed by a decrease in the temperature of the process within the range of from 2 or 3 to 5 to 10 or 15 or 20° C. relative to the pre-heating temperature while performing transverse orientation of the film, followed by a lowering of the temperature within the range of from 5° C. to 10 or 15 or 20 or 30 or 40° C. relative to the melt point temperature, holding or slightly decreasing (more than 5%) the amount of stretch, to allow the film to anneal. The latter step imparts the low TD shrink characteristics of the films described herein. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Thus, in certain embodiments the film(s) described herein are biaxially oriented with at least a 5 or 6 or 7 or 11-fold TD orientation and at least a 2 or 3 or 7-fold MD orientation. Being so formed, the at least three-layer (one core, two skin layers, 18-21 μm thickness) possess an ultimate tensile strength within the range of from 100 or 110 to 80 or 90 or 250 MPa in the TD in certain embodiments; and possess an ultimate tensile strength within the range of from 30 or 40 to 150 or 130 MPa in the MD in other embodiments.

Further example embodiments of the disclosed invention have the following composition and structure. In example embodiments, the polyethylene film may include a core layer comprising at least about 80 wt. %, at least about 85 wt. %, at least about 90 wt. %, at least about 95 wt. % or more of high-density polyethylene, optionally in combination with one or more additives. In optional embodiments, the core layer may also include polyethylene polymers and/or polyethylene hydrocarbon resins. Further, the polyethylene film may include, optionally, a first tie layer on a first side of the core layer and/or a second tie layer on a second side of the core layer, wherein each of the first tie layer and second tie layer may have the same or different composition, wherein each of the first tie layer and second tie layer may include at least about 60 wt. % high-density polyethylene, 65 wt. % high-density polyethylene, 70 wt. % high-density polyethylene, 75 wt. % high-density polyethylene, 80 wt. % high-density polyethylene, 85 wt. % high-density polyethylene, 90 wt. % high-density polyethylene, or more, and, optionally, in combination with one or more additives. Further still, the polyethylene film may a non-scalable, external, matte skin layer having a minimum haze of about 60% under ASTM D-1003 and a maximum gloss at 45′ of about 15 under ISO2813, wherein said matte skin layer is located directly on the core or any tic layer of the polyethylene film, save optional primer(s) therebetween. The matte skin layer may include wax, fluoropolymer, and/or stabilizer, whether each, two or all three of those processing aids, and may optionally include one or more additives. Other than the optional presence of processing aids and/or additives, the polymers in the matte skin layer may include at least about 80 wt. % of polyethylene resin(s), at least about 85 wt. % of polyethylene resin(s), at least about 90 wt. % of polyethylene resin(s), at least about 95 wt. % of polyethylene resin(s), at least about 98 wt. % of polyethylene resin(s) or more.

In addition to the inventive polyethylene film examples described herein and in the preceding paragraph, the polyethylene film may include a skin layer on a side of the polyethylene film opposite to another side of the polyethylene film having the non-scalable, external, matte skin layer. That skin layer may comprise, consists essentially of, or consists of ethylene-propylene copolymer(s) and/or terpolymer(s), optionally in combination with antiblock, which is optionally in polyethylene masterbatch solution so as to maintain the all-polyethylene-based polymer composition of the disclosed polyethylene films herein, excluding the possibility of non-polyethylene-based polymers that may be present in trace quantities as impurities or otherwise.

Building on further example embodiments of the above-described inventive polyethylene film in the immediate two paragraphs and elsewhere in this disclosure, the polyethylene may be coextruded, monoaxially oriented, biaxially oriented, contain one or more additives in any one or more layers of the polyethylene film, metallized, coated, primed, and/or laminated to a laminating substrate, including itself. Furthermore, the above-described polyethylene film may be a film or a label and optionally have an adhesive thereto as well as optionally include a release liner.

### INDUSTRIAL APPLICABILITY

The disclosed multilayered “films,” i.e., inclusive of labels as previously noted, may be stand-alone films, laminates, or webs. Or, the multilayered films may be sealed, coated, metallized, and/or laminated to other film structures. The laminating substrate, itself, may for instance, be a BOPP, BOPE, or a non-oriented, cast or blown PP or PE film or other polymer film with or without the assistance of adhesive(s), increases in temperature and/or pressure, water or solvents, etc.; furthermore, the laminating substrate may or may not be metallized and/or coated. The disclosed multilayered films may be prepared by any suitable methods comprising the steps of co-extruding a multilayered film according to the description and claims of this specification, orienting and preparing the film for intended use such as by coating, printing, slitting, or other converting methods.

For some applications, it may be desirable to laminate the multilayered films to other polymeric film or paper products for purposes such as package decor including printing and metallizing. These activities are typically performed by the ultimate end-users or film converters who process films for supply to the ultimate end-users.

The prepared multilayered film may be used as a packaging film to package an article or good, such as a food item or other product. In some applications, the film may be formed into a pouch type of package, such as may be useful for packaging a beverage, liquid, granular, or dry-powder product. And in some applications, the multilayered film may be a label.

While the foregoing is directed to example embodiments of the disclosed invention, other and further embodiments may be devised without departing from the basic scope thereof, wherein the scope of the disclosed compositions, systems and methods are determined by one or more claims.

1. A polyethylene film comprising:
a core layer comprising at least about 80 wt. % high-density polyethylene;
optionally, a first tie layer on a first side of the core layer, wherein the first tie layer comprises at least about 60 wt. % high-density polyethylene;
optionally, a second tie layer on a second side of the core layer, wherein the second tie layer comprises at least about 60 wt. % high-density polyethylene; and
a non-sealable, external, matte skin layer having a minimum haze of about 60% under ASTM D-1003 and a maximum gloss at 45′ of about 15 under ISO2813.
wherein the polyethylene film has a dull appearance and does not heat-seal on a polyethylene laminate before shrinking or deforming the polyethylene film.

2. The polyethylene film of claim 1, further comprising presence of the first tie layer in the polyethylene film.

3. The polyethylene film of claim 2, further comprising presence of the second tie layer in the polyethylene film.

4. The polyethylene film of claim 3, further comprising a skin layer on a side of the polyethylene film opposite to another side of the polyethylene film having the non-sealable, external, matte skin layer.

5. The polyethylene film of claim 1, further comprising wax, fluoropolymer, and/or stabilizer in the non-sealable, external, matte skin layer.

6. The polyethylene film of claim 1, further comprising at least two of wax, fluoropolymer, and/or stabilizer in the non-sealable, external, matte skin layer.

7. (canceled).

8. The polyethylene film of claim 1, further comprising a skin layer on a side of the polyethylene film opposite to another side of the polyethylene film having the non-sealable, external, matte skin layer.

9. (canceled)

10. (canceled)

11. (canceled)

12. The polyethylene film of claim 8, wherein the skin layer consists essentially of: (i) ethylene-propylene copolymer(s) and/or terpolymer(s); and (ii) antiblock.

13. The polyethylene film of claim 1, wherein the non-sealable, external, matte skin layer consists essentially of polyethylene resin(s) and one or more processing aids.

14. (canceled)

15. The polyethylene film of claim 1, wherein the non-sealable, external, matte skin layer consists essentially of polyethylene resin(s), one or more processing aids, and one or more additives.

16. (canceled)

17. The polyethylene film of claim 1, wherein the non-sealable, external, matte skin layer comprises at least about 80 wt. % of polyethylene resin(s).

18. (canceled)

19. (canceled)

20. (canceled)

21. The polyethylene film of claim 1, wherein the non-sealable, external, matte skin layer consists of polyethylene resin(s).

22. (canceled)

23. The polyethylene film of claim 1, wherein the polyethylene film is monoaxially oriented.

24. The polyethylene film of claim 1, wherein the polyethylene film is biaxially oriented.

25. The polyethylene film of claim 1, wherein polymers in the polyethylene film exclude non-polyethylene-based polymers that are not in trace quantities.

26. The polyethylene film of claim 1, further comprising one or more additives in any one or more layers of the polyethylene film.

27. The polyethylene film of claim 1, wherein the polyethylene film is metallized, coated, primed, laminated, or combinations thereof.

28. (canceled)

29. (canceled)

30. (canceled)

31. The polyethylene film of claim 1, wherein the core layer further comprises polyethylene polymers and/or polyethylene hydrocarbon resins.

32. The polyethylene film of claim 1, wherein the polyethylene film is a label.

33. The polyethylene film of claim 32, further comprising an adhesive.
